(19) United States
(12) Patent Application Publication
(10) Pub. No.: US 2025/0165180 A1
(43) Pub. Date: May 22, 2025

(54) RECOVERY METHOD FOR ALL-FLASH STORAGE SYSTEM, AND RELATED APPARATUS

(71) Applicant: IEIT SYSTEMS CO., LTD., Jinan (CN)

(72) Inventors: Kai ZHANG, Jinan (CN); Yazhou GANG, Jinan (CN); Jian WANG, Jinan (CN)

(73) Assignee: IEIT SYSTEMS CO., LTD., Jinan (CN)

(21) Appl. No.: 19/029,708

(22) Filed: Jan. 17, 2025

Related U.S. Application Data
(63) Continuation of application No. PCT/CN2023/081445, filed on Mar. 14, 2023.

(30) Foreign Application Priority Data
Oct. 10, 2022 (CN) 202211231242.2

(51) Int. Cl. G06F 3/06

(52) U.S. Cl. CPC G06F 3/0655; G06F 3/0604; G06F 3/0679

(57) ABSTRACT

The present application relates to the technical field of storage. Disclosed is a method of recovering an all-flash storage system. The method comprises: when metadata of a logical volume has not been modified, marking the state of the metadata of the logical volume as a clean state; after the power to an all-flash storage system is restored, reading the state of the metadata of the logic volume; and if the metadata of the logical volume is in the clean state, restoring the metadata of the logical volume to an accessible state. The method can implement rapid recovery after a power loss failure of an all-flash storage system occurs, thereby shortening the recovery time and improving the availability, reliability and security of the whole storage system.

### CROSS-REFERENCE TO RELATED APPLICATION

This application is a National Stage Application of International Application No. PCT/CN2023/081445 filed on Mar. 14, 2023, which claims the benefit of Ser. No. 202211231242.2 filed on Oct. 10, 2022 in China, and which applications are incorporated herein by reference. To the extent appropriate, a claim of priority is made to each of the above disclosed applications.

### TECHNICAL FIELD

The present application relates to the technical field of storage, and in particular, to a method of recovering an all-flash storage system, and also relates to an apparatus and a device of recovering an all-flash storage system, and a non-volatile computer readable storage medium.

### BACKGROUND

Metadata refers to data describing data. In an all-flash storage system, metadata management is vital. The metadata management mainly manages an L-P mapping (a mapping relationship from a logical block address to a physical block address), and a P-L mapping (a mapping relationship from a physical block address to a logical block address), etc. Due to a large amount of high-concurrency and low-latency data access, metadata in all-flash storage systems is typically organized using a tree data structure. Due to the limited storage capacity, a large amount of metadata management needs to be solidified and saved, which involves flushing a disk and allocating metadata space on the disk. When a power failure occurs, a software or hardware failure of a loss of a non-volatile memory may lead to a storage system node failure, which further causes unavailability of an all-flash storage system, and it needs to be recovered to continue processing services. The length of the recovery time of the all-flash storage system determines the interruption time of the client service, and the length of the recovery time of the all-flash storage system also reflects the availability, reliability and security of the entire storage system.

Therefore, how to shorten the recovery time and improve the availability, reliability and security of the entire storage system has become a technical problem to be solved urgently by those skilled in the art.

### SUMMARY

An objective of the present application is to provide a method of recovering an all-flash storage system, which can implement rapid recovery after a power loss failure of an all-flash storage system occurs, thereby shortening the recovery time and improving the availability, reliability and security of the whole storage system. Another objective of the present application is to provide an apparatus and a device of recovering an all-flash storage system, and a non-volatile computer readable storage medium, which all have the above technical effects.

In order to solve the described technical problem, the present application provides a method of recovering an all-flash storage system, including:
in a case where metadata of a logical volume has not been modified, marking a state of the metadata of the logical volume as a clean state;
after an all-flash storage system is powered back on, reading the state of the metadata of the logic volume; and
in a case where the metadata of the logical volume is in the clean state, restoring the metadata of the logical volume to an accessible state (namely, a state that is accessible to a user).

Optionally, in a case where metadata of a logical volume has not been modified, marking a state of the metadata of the logical volume as a clean state includes:
in a case where, within a preset timing period, there is no user-accessible data dispatched for the logical volume and the metadata of the logical volume has been written from a cache to a data storage device, marking the state of the metadata of the logical volume as the clean state.

Optionally, in a case where, within a preset timing period, there is no user-accessible data dispatched for the logical volume and the metadata of the logical volume has been written from the cache to the data storage device, marking the state of the metadata of the logical volume as the clean state includes:
starting an idle task of writing the metadata of the logical volume from the cache to the data storage device, and determining whether the metadata of the logical volume has been written from the cache to the data storage device;
in a case where the metadata of the logical volume has been written from the cache to the data storage device, initiating a request for changing the state of the metadata as the clean state, to cause a control end of a state machine to trigger the state machine to run, and initiate a task of changing the state of the metadata as the clean state; and
executing the task, and marking the state of the metadata of the logical volume as the clean state.

Optionally, in a case where the metadata of the logical volume is in the clean state, the restoring the metadata of the logical volume to an accessible state (namely, a state that is accessible to a user) includes:
in a case where the metadata of the logical volume is in the clean state, determining that forward metadata is stored in a hard disk, the forward metadata being configured to indicate a mapping relationship from a logical block address to a physical block address; and
reading the forward metadata from the hard disk to a memory, and restoring the metadata of the logical volume to the accessible state

Optionally, the marking a state of the metadata of the logical volume as a clean state includes:
marking, in the logical volume, the state of the metadata of the logical volume as the clean state.

Optionally, marking, in the logical volume, the state of the metadata of the logical volume as the clean state includes:
marking, in a superblock of a header of the logical volume, the state of the metadata of the logical volume as the clean state.

Optionally, the marking a state of the metadata of the logical volume as a clean state includes:
marking, at a location other than the logical volume, the state of the metadata of the logical volume as the clean state.

Optionally, the method further includes:
in a case where the metadata of the logical volume has not been modified, writing, into a superblock of a header of the logical volume, a root node address of a tree structure where the metadata is located.

Optionally, the writing, into a superblock of a header of the logical volume, a root node address of a tree structure where the metadata is located includes:
writing, into the superblock of the header of the logical volume, a root node address of a B+ tree where the metadata is located.

Optionally, writing, into the superblock of the header of the logical volume, the root node address of the tree structure where the metadata is located includes:
in a case where, within a timing period, there is no user-accessible data dispatched for the logical volume and all modified metadata has been written from the cache to the data storage device, determining that all nodes of the B+ tree are in the clean state, wherein in a case where there is written data, a corresponding node on the B+ tree becomes a dirty state; and marking, in the superblock of the logical volume, the state of the metadata of the logical volume as the clean state, and writing the root node address of the B+ tree.

Optionally, the method further includes:
reading the root node address; and
accessing forward metadata of the logical volume according to the root node address.

Optionally, the method further includes:
in a case where the metadata of the logical volume has been modified, marking the state of the metadata of the logical volume as a dirty state.

Optionally, the marking the state of the metadata of the logical volume as the dirty state includes:
marking, in the logical volume, the state of the metadata of the logical volume as the dirty state.

Optionally, the marking, in the logical volume, the state of the metadata of the logical volume as the dirty state includes:
marking, in a superblock of a header of the logical volume, the state of the metadata of the logical volume as the dirty state.

Optionally, in a case where the metadata of the logical volume has been modified, marking the state of the metadata of the logical volume as the dirty state includes:
in a case where there is written data dispatched for the logical volume, determining whether the state of the metadata of the logical volume is the clean state;
in a case where the state of the metadata of the logical volume is the clean state, initiating a request for changing the state of the metadata as the dirty state, to cause a control end of a state machine to trigger the state machine to run, and initiate a task of changing the state of the metadata as the dirty state; and
executing the task, and marking the state of the metadata of the logical volume as the dirty state.

Optionally, the method further includes:
reconstructing forward metadata being configured to indicate a mapping relationship from a logical block address to a physical block address in a case where the state of the metadata of the logical volume is the dirty state, and restoring the metadata of the logical volume to the accessible state after the forward metadata is reconstructed.

Optionally, the reconstructing the forward metadata includes:
reading a logical partition space of the logical volume in a physical disk, and reconstructing the forward metadata using backward metadata.

Optionally, the method further includes:
in a case where the state of the metadata of the logical volume is the clean state, and each time new user-accessible data is written, inserting a new mapping relationship from a logical block address to a physical block address into the tree structure, to cause at least one node of the tree structure to be changed to be modified and cause the tree structure to be in the dirty state.

In order to solve the described technical problem, the present application also provides a device of recovering an all-flash storage system, including:
a memory, configured to store a computer program;
a processor, configured to implement the steps of the method of recovering the all-flash storage system as stated above when executing the computer program.

In order to solve the described technical problem, the present application also provides a non-volatile computer readable storage medium, and the non-volatile computer readable storage medium stores a computer program which, when executed by the processor, implements the steps of the method of recovering the all-flash storage system as stated above.

The method of recovering an all-flash storage system provided in the present application includes: in a case where metadata of a logical volume has not been modified, marking a state of the metadata of the logical volume as a clean state; after an all-flash storage system is powered back on, reading the state of the metadata of the logic volume; and in a case where the metadata of the logical volume is in the clean state, making the logical volume back online.

Hence, according to the method of recovering the all-flash storage system provided in the present application, in a case where the metadata of a logical volume is in a clean state, the state of the metadata is marked as a clean state, and subsequently, after a power loss failure occurs in an all-flash storage system and power is restored, in a case where the state of the metadata of the logical volume is the clean state, power is directly restored, without the need of reconstructing the forward metadata, thereby achieving quick recovery after a power loss failure of an all-flash storage system occurs, shortening the recovery time, and improving the availability, reliability and security of the entire storage system.

The recovery apparatus and device for the all-flash storage system, and the non-volatile computer readable storage medium provided in the present application all have the described technical effects.

### BRIEF DESCRIPTION OF THE DRAWINGS

To describe the technical solutions in the embodiments of the present application more clearly, the following briefly describes the accompanying drawings required for describing the prior art and the embodiments. Apparently, the accompanying drawings in the following description show merely some embodiments of this application, and a person of ordinary skill in the art may still derive other accompanying drawings from these accompanying drawings without creative efforts.

FIG. 1 is a schematic flowchart of a method of recovering an all-flash storage system according to an embodiment of the present application;

FIG. 2 is a flowchart of TO_CLEAN according to an embodiment of the present application;

FIG. 3 is a flowchart of a TO_DIRTY according to an embodiment of the present application;

FIG. 4 is a schematic diagram of an apparatus of recovering an all-flash storage system according to an embodiment of the present application;

FIG. 5 is a schematic flowchart of a device of recovering an all-flash storage system according to an embodiment of the present application.

### DETAILED DESCRIPTION OF THE EMBODIMENTS

The core of the present application is to provide a method of recovering an all-flash storage system, which can implement rapid recovery after a power loss failure of an all-flash storage system occurs, thereby shortening the recovery time and improving the availability, reliability and security of the whole storage system. Another core of the present application is to provide a recovery apparatus and device for an all-flash storage system, and a non-volatile computer readable storage medium, which all have the above technical effects.

To make the objects, technical solutions, and advantages of the embodiments of the present disclosure clearer, hereinafter, the technical solutions in the embodiments of the present application will be described clearly and thoroughly with reference to the accompanying drawings of the embodiments of the present application. Obviously, the embodiments as described are some of the embodiments of the present application, and are not all of the embodiments of the present application. All other embodiments obtained by those of ordinary skill in the art on the basis of the embodiments in the application without creative work shall fall within the scope of protection of the

In a conventional technical solution, when an all-flash storage system is normal, the state of metadata of a logical volume is not marked, and when a power loss failure occurs in the all-flash storage system, regardless of the state of the metadata of the logical volume before the power loss failure, forward metadata is first reconstructed after power is recovered, which causes a slow recovery speed. In order to solve the described defects existing in conventional technical solutions, the present application provides a method of recovering an all-flash storage system, which can implement rapid recovery after a power loss failure of an all-flash storage system occurs, thereby shortening the recovery time.

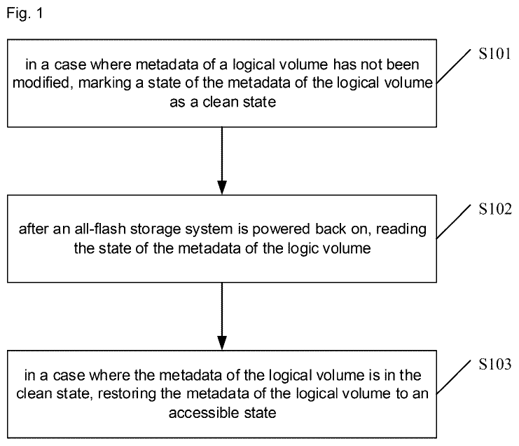

Please refer to FIG. 1, FIG. 1 is a schematic flowchart of a method of recovering an all-flash storage system according to an embodiment of the present application. With reference to FIG. 1, the method includes:
S101: in a case where metadata of a logical volume has not been modified (namely, in a case where metadata of a logical volume is clean), the state of the metadata of the logical volume is marked as a clean state;
Clean refers to that flushing of metadata of a logical volume is completed (namely, an operation of writing the metadata of the logical volume from a cache to a data storage device is completed). If flushing of metadata is not completed, that is, the memory has no metadata which has been flushed, the metadata of the logical volume has been modified. When the all-flash storage system is normal, if the metadata of the logical volume has not been modified, the state of the metadata of the logical volume may be marked as clean.

In some embodiments, in a case where metadata of a logical volume has not been modified, marking a state of the metadata of the logical volume as a clean state includes: in a case where, within a preset timing period, there is no user-accessible data dispatched for the logical volume and the metadata of the logical volume has been written from a cache to a data storage device, marking the state of the metadata of the logical volume as the clean state.

In the present embodiment, the condition of the metadata of the logical volume has not been modified is that within a preset timing period, there is no user-accessible data dispatched for the logical volume and the metadata of the logical volume has been written from a cache to data storage device. in a case where, the above condition is met, the metadata of the logical volume as a clean state. Otherwise, the metadata of the logical volume as a dirty state.

in a case where the metadata of the logical volume has not been modified, each time a new IO (namely, user-accessible data) is written, a new LP mapping relationship (namely, a new mapping relationship from a logical block address to a physical block address) is generated, and the state of the metadata of the logical volume is changed as a dirty state. In a case where, within a preset timing period, there is no user-accessible data dispatched for the logical volume and all the modified metadata has been written from a cache to a data storage device, the state of the metadata of the logical volume is changed as a clean state. In a case where the metadata of the logical volume has not been modified, the state of the metadata of the logical volume is marked as the clean state. If a power loss failure occurs in the all-flash storage system subsequently, after the all-flash storage system is restored to be powered, it may be learned, by reading a flag, whether the state of metadata of the logical volume, before the power loss failure, is the clean state.

It should be noted that, it needs to be ensured that the marked clean state of the metadata will not be lost after the all-flash storage system is restored to be powered, and the marked clean state of the metadata can be acquired normally. On this premise, the manner of marking the state of the metadata of the logical volume may be set differently. For example, the metadata of the logical volume may be marked as clean state in the logical volume itself. The metadata of the logical volume may also be marked as a clean state at other positions other than the logical volume.

In order to mark the state more pertinently and facilitate reading the state of the metadata of the logical volume, in some embodiments, the marking a state of the metadata of the logical volume as a clean state includes: marking, in the logical volume, the state of the metadata of the logical volume as the clean state.

In the present embodiment, the clean state of the metadata of the logical volume is marked in the logical volume. When the state of the metadata of the logical volume needs to be read, the metadata may be read from the logical volume.

Marking, in the logical volume, the state of the metadata of the logical volume as the clean state includes:
marking, in a superblock of a header of the logical volume, the state of the metadata of the logical volume as the clean state.

In the present embodiment, the region for marking the clean state of the metadata of the logical volume is a superblock at the header of the logical volume. If the metadata of the logical volume has not been modified, the state of the metadata of the logical volume is marked as a clean state in the superblock of the logical volume.

In addition, when within a preset timing period, the logical volume has no IO dispatch and the metadata of the logical volume has been flushed, marking the state of the metadata of the logical volume as the clean state includes:
starting an idle task of writing the metadata of the logical volume from the cache to the data storage device, and determining whether the metadata of the logical volume has been written from the cache to the data storage device;
in a case where the metadata of the logical volume has been written from the cache to the data storage device, initiating a request for changing the state of the metadata as the clean state, to cause a control end of a state machine to trigger the state machine to run, and initiate task of changing the state of the metadata as the clean state; and
executing the task, and marking the state of the metadata of the logical volume as the clean state.

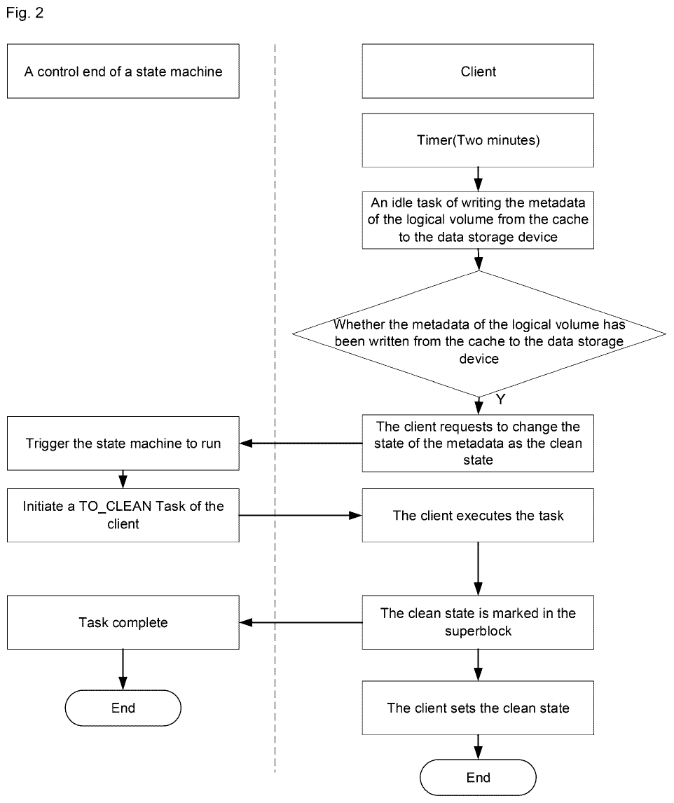

With reference to the task of changing the state of the metadata as the clean state flow shown in FIG. 2, the timer of the client is set to 2 minutes (or may be set to other durations), the idle task of writing the metadata of the logical volume from the cache to the data storage device, and it is determined whether the metadata of the logical volume has been written from the cache to the data storage device, the state of the metadata is requested by the client to be changed as the clean state. The control end of the state machine triggers the running of the state machine, and initiates a task of changing the state of the metadata as the clean state, i.e., initiating the task of changing the state of the metadata as the clean state. Then, the client executes the task, and marks, in the spuerblock of the logical volume, the state of the metadata of the logical volume as a clean state.

S102: after an all-flash storage system is powered back on, reading the state of the metadata of the logic volume;
S103: in a case where the state of the metadata of the logical volume is the clean state, restoring the metadata of the logical volume to an accessible state (namely, a state that is accessible to a user) accessible by users.

When a power loss failure occurs in the all-flash storage system and power is restored, the state of the metadata of the logical volume is read first. When the state of the metadata of the logical volume is marked in the superblock of the logical volume, the state of the metadata of the logical volume, which is marked in the superblock of the logical volume, is read first. If the read state of the metadata of the logical volume is a clean slate, it indicates that the hard disk or the magnetic disk has forward metadata, and the forward metadata may be directly read from the hard disk or the magnetic disk into the memory. In this case, restoring the metadata of the logical volume to the accessible state, without the need of reconstructing the forward metadata. The forward metadata refers to the metadata that is mapped from a logical block address to a physical block address.

In some embodiments, the method can further include:
in a case where the metadata of the logical volume has not been modified, writing, into a superblock of a header of the logical volume, a root node address of a tree structure where the metadata is located.

In the present embodiment, the metadata of the logical volume is organized using a tree structure. When the state of the metadata of the logical volume is the clean state, each time new user-accessible data is written, a new LP mapping relationship, i.e., a mapping relationship from the logical block address to the physical block address, is inserted into the tree (namely tree structure), so that at least one node of the tree is changed to be modified (dirty), and in this case, the whole tree is in the dirty state. When within a preset timing period, there is no user-accessible data dispatched for the logical volume and all the modified metadata has been written from a cache to a data storage device, the whole tree is in the clean state. In this case, the metadata of the logical volume may be marked as the clean state in the superblock of the logical volume, and the root node address of the tree may be written at the same time.

Writing, wherein the writing, into a superblock of a header of the logical volume, a root node address of a tree structure where the metadata is located includes:
writing, into the superblock of the header of the logical volume, a root node address of a B+ tree where the metadata is located.

The B+ tree index has a lookup time complexity of O(log n) and a space usage rate of 75% (the non-leaf node serves as an index node and does not serve as a node for storing data). The B+ tree search starts from the root node and then traverses down level by level until it reaches the leaf node, and therefore a non-leaf node is an important node in the search process and is a most frequently accessed node. In addition, the lower the level of the node, the higher the frequency of access, so it is best to keep as many lower-level non-leaf nodes in memory as possible. The B+ tree has better search efficiency, and is more suitable for organizing metadata object; therefore, in the present embodiment, the B+ tree is used by the tree to support the effective search of metadata object inside an all-flash storage system.

When the metadata of the logical volume is in the clean state, each time new user-accessible data is written, a new LP mapping relationship (namely, a new mapping relationship from a logical block address to a physical block address) is inserted into the B+ tree, so that at least one node of the B+ tree is changed to be dirty (namely, be modified), and at this time, the whole B+ tree is in the dirty state. When within a timing period, there is no user-accessible data dispatched for the logical volume and all modified metadata has been written from the cache to the data storage device, the whole B+ tree is in the clean state. In this case, the metadata of the logical volume may be marked as the clean state in the superblock of the logical volume, and the root node address of the B+ tree is written.

On the basis of organizing the metadata in the tree structure and marking the root node address of the tree structure where the metadata is located, the method can further include:
reading the root node address; and
accessing forward metadata of the logical volume according to the root node address.

After the power of the all-flash storage system is restored, when the metadata of the logical volume is in the clean state, power may be restored directly, and forward metadata of the logical volume may be accessed according to the root node address.

In some embodiments, the method can further include:
in a case where the metadata of the logical volume has been modified, marking the state of the metadata of the logical volume as a dirty state.

In the present embodiment, when metadata of a logical volume has not been modified, the state of the metadata of the logical volume is marked as a clean state. When the metadata of the logical volume has been modified, the state of the metadata of the logical volume is marked as a dirty state. When the metadata of the logical volume has not been modified, each time new user-accessible data (namely, a new IO) is written, a new LP mapping relationship (namely, a new mapping relationship from a logical block address to a physical block address) is generated, and the state of the metadata of the logical volume is changed as a dirty state. If the metadata of the logical volume has been modified, the metadata of the logical volume is marked as dirty (namely, be modified). If a power loss failure occurs in the all-flash storage system subsequently, after the all-flash storage system is restored to be powered, it may be learned, by reading a flag, whether the state of metadata of the logical volume, before the power loss failure, is the dirty state.

Likewise, the state of the metadata of the logical volume may be marked as the clean state in the logical volume itself. The state of the metadata of the logical volume may also be marked as a dirty state at other positions other than the logical volume.

In order to mark the state in a more targeted manner and facilitate reading the state of the metadata of the logical volume, the marking the state of the metadata of the logical volume as the dirty state may include:
marking, in the logical volume, the state of the metadata of the logical volume as the dirty state.

In the present embodiment, the dirty state of the metadata of the logical volume is also marked in the logical volume. When the state of the metadata of the logical volume needs to be read, it can be learned, by reading the logical volume, whether the metadata of the logical volume is in the clean state or the dirty state.

Marking, in the logical volume, the state of the metadata of the logical volume as the dirty state includes: marking, in a superblock of a header of the logical volume, the state of the metadata of the logical volume as the dirty state.

In the present embodiment, the region for marking the dirty state of the metadata of the logical volume is a superblock at the header of the logical volume. If the metadata of the logical volume has been modified, the state of the metadata of the logical volume is marked as a dirty state in the superblock of the logical volume.

In addition, in a case where the metadata of the logical volume has been modified, marking the state of the metadata of the logical volume as the dirty state may include:
in a case where there is written data (namely, an IO) dispatched for the logical volume, determining whether the state of the metadata of the logical volume is the clean state;
in a case where the state of the metadata of the logical volume is the clean state, initiating a request for changing the state of the metadata as the dirty state, to cause a control end of a state machine to triggers the state machine to run, and initiate a task of changing the state of the metadata as the dirty state; and
executing the task, and marking the state of the metadata of the logical volume as the dirty state.

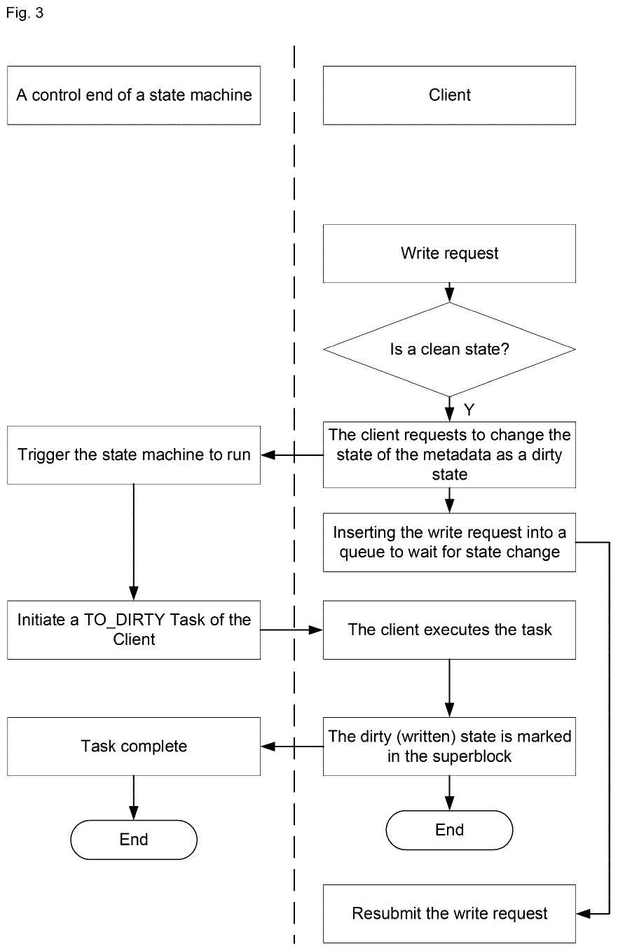

Refer to the task of changing the state of the metadata as the dirty state flow shown in FIG. 3, the client determines whether the metadata of the logical volume has not been modified. If the metadata of the logical volume has not been modified, the client requests to change the state of the metadata as a dirty state. The control end of the state machine triggers the running of the state machine, and initiates a task of changing the state of the metadata as the clean state to the client, i.e., initiating a task of changing the state of the metadata as the dirty state. The client executes the task and marks the dirty state in the superblock of the logical volume.

In addition to marking the state of the metadata of the logical volume and the root node address in the superblock of the header of the logical volume, information such as grainsize may also be marked in the superblock of the header of the logical volume.

In some embodiments, the method can further include:
reconstructing forward metadata being configured to indicate a mapping relationship from a logical block address to a physical block address in a case where the state of the metadata of the logical volume is the dirty state, restructing the forward metadata.

In cases where the metadata of the logical volume is marked as a dirty state, when the marked state of the metadata of the logical volume is read and the read state of the metadata of the logical volume is the dirty state, the forward metadata needs to be first reconstructed, and then power is restored after the forward metadata is reconstructed.

Reconstructing the forward metadata includes:
reading a logical partition space of the logical volume in a physical disk, and reconstructing the forward metadata using backward metadata.

Backward metadata refers to metadata mapped from the physical block address to the logical block address. After the power of the all-flash storage system is restored, in cases where the state of the metadata of the logical volume is the dirty state, the logical partition space of the logical volume in the physical disk is read first, and the forward metadata of the logical volume is reconstructed by means of the backward metadata. For an implementation process of reconstructing forward metadata by means of backward metadata, no further details are provided herein, and reference may be made to the prior art.

The power recovery process after a power loss failure occurs in an all-flash storage system is described by means of an optional embodiment as follows:
when the metadata of the logical volume is in the clean state, each time a new IO is written, a new LP mapping relationship is inserted into the B+ tree, so that at least one node of the B+ tree is changed to be dirty (namely, be modified), and in this case, the whole B+ tree is in the dirty state, and in this case, a dirty state is marked in a superblock of the logical volume;
when within a timing period, the logical volume has no IO dispatch and all the modified metadata has been written from the cache to the data storage device, the whole B+ tree is in the clean state. In this case, the clean state is marked in the superblock of the logical volume, and the root node address of the B+ tree is written.

In a fault scenario, such as a power failure and a non-volatile memory loss, occurring in an all-flash storage system, when the power of the all-flash storage system is restored, it is first checked whether the superblock is marked as a clean state or a dirty state.

If it is in the clean state, the power can be restored immediately and the root node address can be acquired, and all the forward metadata of the logical volume can be accessed by means of the root node address.

If it is in the dirty state, it is necessary to read the logic partition space of the logical volume in the physical disk first, and then the forward data of the volume is reconstructed by means of the backward metadata, so as to restore power.

According to the recovery method provided in the foregoing embodiment, by marking the state of metadata and restoring power on the basis of the state of the metadata, rapid recovery of the all-flash storage systems can be achieved in some scenarios, such as unplanned power failure of a system; cluster state abnormality and unavailability due to software failure; failure to store a non-volatile memory due to software faults; loss of non-volatile memory due to software faults; and loss of non-volatile memory due to hardware faults.

In conclusion, the method of recovering the all-flash storage system provided in the present application includes: marking the state of the metadata of the logical volume as a clean state when metadata of a logical volume has not been modified; after the power to an all-flash storage system is restored, reading the state of the metadata of the logic volume; and if the metadata of the logical volume is in the clean state, restoring the metadata of the logical volume to an accessible state (namely, a state that is accessible to a user) accessible by users. Hence, according to the method of recovering the all-flash storage system provided in the present application, when the metadata of a logical volume is in a clean state, the state of the metadata is marked as a clean state, and subsequently, after a power loss failure occurs in an all-flash storage system and power is restored, if the state of the metadata of the logical volume is the clean state, power is directly restored, without the need of reconstructing the forward metadata, thereby achieving quick recovery after a power loss failure of an all-flash storage system occurs, shortening the recovery time, and improving the availability, reliability and security of the entire storage system.

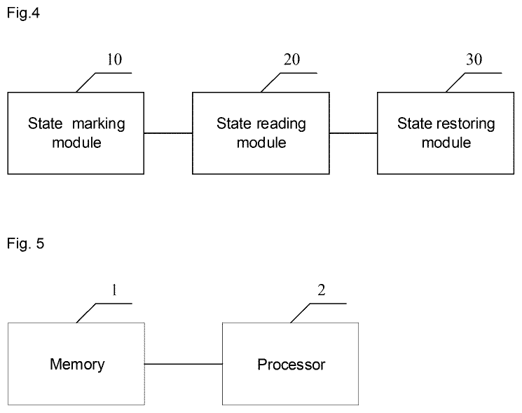

The present application also provides an apparatus of recovering an all-flash storage system. The apparatus described below and the method described above may be mutually corresponded and referred to. Please refer to FIG. 4, FIG. 4 is a schematic diagram of an apparatus of recovering an all-flash storage system according to an embodiment of the present application. As shown in FIG. 4, the apparatus includes:
a state marking module 10, configured to mark a state of the metadata of the logical volume as a clean state when metadata of a logical volume has not been modified;
a state reading module 20, configured to read the state of the metadata of the logic volume after an all-flash storage system is powered back on; and
a state restoring module 30, configured to restore the metadata of the logical volume to an accessible state in a case where the metadata of the logical volume is in the clean state.

When the flash storage system is normal, if the metadata of the logical volume has not been modified, the state of the metadata of the logical volume may be marked as the clean state. When a power loss failure occurs in the all-flash storage system and power is restored, the state of the metadata of the logical volume is read first. If the read state of the metadata of the logical volume has not been modified, the power is restored directly, without the need of reconstructing the forward metadata.

On the basis of the foregoing embodiment, as an optional implementation, the state marking module 10 is configured to:
in a case where, within a preset timing period, there is no user-accessible data dispatched for the logical volume and the metadata of the logical volume has been written from the cache to the data storage device, mark the state of the metadata of the logical volume as the clean state.

In the present embodiment, the condition of determining that the metadata of the logical volume has not been modified is that within a preset timing period, there is no user-accessible data dispatched for the logical volume and the metadata of the logical volume has been written from the cache to the data storage device. If the above condition is met, the metadata of the logical volume has not been modified (namely, be clean). Otherwise, the metadata of the logical volume has been modified (namely, be dirty).

When the metadata of the logical volume has not been modified, each time a new IO (namely, user-accessible data) is written, a new LP mapping relationship (namely, a new mapping relationship from a logical block address to a physical block address) is generated, and the metadata of the logical volume becomes dirty (namely, it is indicated that the metadata of the logical volume has been modified). When within a preset timing period, the logical volume has no user-accessible data dispatched and all the modified metadata has been written from a cache to a data storage device (namely, all the modified metadata has been flushed), the metadata of the logical volume becomes clean (namely, it is indicated that the metadata of the logical volume has not been modified). If the metadata of the logical volume has not been modified, the state of the metadata of the logical volume is marked as a clean state. If a power loss failure occurs in the all-flash storage system subsequently, after the all-flash storage system is restored to be powered, it may be learned, by reading a flag, whether the metadata of the logical volume, before the power loss failure, has not been modified.

On the basis of the foregoing embodiment, as an optional implementation, the state marking module 10 is configured to:
mark, in the logical volume, the state of the metadata of the logical volume as the clean state.

In order to mark the state in a more targeted manner and facilitate reading the state of the metadata of the logical volume, in the present embodiment, the clean state of the metadata of the logical volume is marked in the logical volume. When the state of the metadata of the logical volume needs to be read, the metadata may be read from the logical volume.

On the basis of the foregoing embodiment, as an optional implementation, the state marking module 10 is configured to:
marking, in a superblock of a header of the logical volume, the state of the metadata of the logical volume as the clean state.

In the present embodiment, the region for marking the clean state of the metadata of the logical volume is a superblock at the header of the logical volume. If the metadata of the logical volume has not been modified, the state of the metadata of the logical volume is marked as a clean state in the superblock of the logical volume.

On the basis of the foregoing embodiment, as an optional implementation, the state marking module 10 is configured to:
start an idle task of writing the metadata of the logical volume from the cache to the data storage device, and determine whether the metadata of the logical volume has been written from the cache to the data storage device;
in a case where the metadata of the logical volume has been written from the cache to the data storage device, initiate a request for changing the state of the metadata as the clean state, to cause a control end of a state machine to trigger the state machine to run to initiate a task of changing the state of the metadata as the clean state; and
execute the task, and mark the state of the metadata of the logical volume as the clean state.

On the basis of the foregoing embodiment, as an optional implementation, the apparatus further includes:
an address marking module, configured to write, into a super block of a header of the logical volume and when the metadata of the logical volume is in the clean state, a root node address of a tree structure where the metadata is located.

In the present embodiment, the metadata of the logical volume is organized using a tree structure. When the metadata of the logical volume has not been modified, each time a new IO (namely, user-accessible data) is written, a new LP mapping relationship, i.e., a mapping relationship from the logical block address to the physical block address, is inserted into the tree, so that it is indicated that at least one node of the tree has been modified, and in this case, the whole tree is in the dirty state. When within a preset timing period, the logical volume has no user-accessible data dispatched and all the modified metadata has been written from a cache to a data storage device, the whole tree is in the clean state. In this case, the metadata of the logical volume may be marked as the clean state in the superblock of the logical volume, and the root node address of the tree may be written at the same time.

On the basis of the foregoing embodiment, as an optional implementation, the address marking module is configured to:
write, into the superblock of the header of the logical volume, a root node address of a B+ tree where the metadata is located.

The B+ tree index has a lookup time complexity of O(log n) and a space usage rate of 75% (the non-leaf node serves as an index node and does not serve as a node for storing data). The B+ tree search starts from the root node and then traverses down level by level until it reaches the leaf node, and therefore a non-leaf node is an important node in the search process and is a most frequently accessed node. In addition, the lower the level of the node, the higher the frequency of access, so it is best to keep as many lower-level non-leaf nodes in memory as possible. The B+ tree has better search efficiency, and is more suitable for organizing a metadata object; therefore, in the present embodiment, the B+ tree is used by the tree to support effective search of metadata object inside the all-flash storage system.

When the metadata of the logical volume is in the clean state, each time a new IO is written, a new LP mapping relationship is inserted into the B+ tree, so that at least one node of the B+ tree changes to be dirty (namely, it is indicated that at least one node of the B+ tree has been modified), and at this time, the whole B+ tree is in the dirty state. When within a timing period, the logical volume has no IO (namely, user-accessible data) dispatched and all the modified metadata has been written from a cache to a data storage device, the whole B+ tree is in the clean state. In this case, the metadata of the logical volume may be marked as the clean state in the superblock of the logical volume, and the root node address of the B+ tree is written.

On the basis of the foregoing embodiment, as an optional implementation, the apparatus further includes:
an address reading module, configured to read a root node address; and
a metadata access module, configured to access forward metadata of the logical volume according to the root node address.

After the power of the all-flash storage system is restored, when the metadata of the logical volume is in the clean state, power may be restored directly, and forward metadata of the logical volume may be accessed according to the root node address.

On the basis of the foregoing embodiment, as an optional implementation, the state marking module 10 is further configured to:
in a case where the metadata of the logical volume has been modified, mark the state of the metadata of the logical volume as a dirty state.

In the present embodiment, when metadata of a logical volume has not been modified, the state of the metadata of the logical volume is marked as a clean state. When the metadata of the logical volume has been modified, the state of the metadata of the logical volume is marked as a dirty state. When the metadata of the logical volume has not been modified, each time a new IO (namely, user-accessible data) is written, a new LP mapping relationship (namely, a new mapping relationship from a logical block address to a physical block address) is generated, and the metadata of the logical volume becomes dirty (namely, it is indicated that the metadata of the logical volume has been modified). If the metadata of the logical volume has been modified, the state of the metadata of the logical volume is marked as a dirty state. If a power loss failure occurs in the all-flash storage system subsequently, after the all-flash storage system is restored to be powered, it may be learned, by reading a flag, whether the state of metadata of the logical volume, before the power loss failure, is the dirty state.

On the basis of the foregoing embodiment, as an optional implementation, the state marking module 10 is configured to:
mark, in the logical volume, the state of the metadata of the logical volume as the dirty state.

In the present embodiment, the dirty state of the metadata of the logical volume is also marked in the logical volume. When the state of the metadata of the logical volume needs to be read, it can be learned, by reading the logical volume, whether the metadata of the logical volume is in the clean state or the dirty state.

On the basis of the foregoing embodiment, as an optional implementation, the state marking module 10 is configured to:
mark, in a superblock of a header of the logical volume, the state of the metadata of the logical volume as the dirty state.

In the present embodiment, the region for marking the dirty state of the metadata of the logical volume is a superblock at the header of the logical volume. If the state of the metadata of the logical volume is the dirty state, the state of the metadata of the logical volume is marked as a dirty state in the superblock of the logical volume.

On the basis of the foregoing embodiment, as an optional implementation, the apparatus further includes:
a metadata reconstruction module, configured to reconstruct forward metadata in a case where the state of the metadata of the logical volume is the dirty state, and restore the metadata of the logical volume to the accessible state after the forward metadata is reconstructed.

In cases where the metadata of the logical volume is marked as a dirty state, when the marked state of the metadata of the logical volume is read and the read state of the metadata of the logical volume is the dirty state, the forward metadata needs to be first reconstructed, and then power is restored after the forward metadata is reconstructed.

On the basis of the foregoing embodiment, as an optional implementation, the metadata reconstruction module is configured to:
read a logical partition space of the logical volume in a physical disk, and reconstruct the forward metadata using backward metadata.

Backward metadata refers to metadata mapped from the physical block address to the logical block address. After the power of the all-flash storage system is restored, in cases where the state of the metadata of the logical volume is the dirty state, the logical partition space of the logical volume in the physical disk is read first, and the forward metadata of the logical volume is reconstructed by means of the backward metadata. For an implementation process of reconstructing forward metadata by means of backward metadata, no further details are provided herein, and reference may be made to the prior art.

According to the apparatus of recovering the all-flash storage system provided in the present application, when the metadata of a logical volume is in a clean state, the state of the metadata is marked as a clean state, and subsequently, after a power loss failure occurs in an all-flash storage system and power is restored, if the state of the metadata of the logical volume is the clean state, power is directly restored, without the need of reconstructing the forward metadata, thereby achieving quick recovery after a power loss failure of an all-flash storage system occurs, shortening the recovery time, and improving the availability, reliability and security of the entire storage system.

The present application also provides a device of recovering an all-flash storage system. As shown in FIG. 5, the device comprises a memory 1 and a processor 2.

The memory 1 is configured to store a computer program; and

The processor 2 is configured to execute a computer program to implement the following steps:
when the metadata of a logical volume has not been modified, marking the state of the metadata of the logical volume as a clean state; after the power of an all-flash storage system is restored, reading the state of the metadata of the logic volume; and if the metadata of the logical volume is in the clean state, restoring the metadata of the logical volume back online to an accessible state accessible by users.

According to the device of recovering the all-flash storage system provided in the present application, when the metadata of a logical volume is in a clean state, the state of the metadata is marked as a clean state, and subsequently, after a power loss failure occurs in an all-flash storage system and power is restored, if the state of the metadata of the logical volume is the clean state, power is directly restored, without the need of reconstructing the forward metadata, thereby achieving quick recovery after a power loss failure of an all-flash storage system occurs, shortening the recovery time, and improving the availability, reliability and security of the entire storage system.

For the description of the device provided in the present application, reference may be made to the foregoing method embodiments, and details are not repeatedly described in the present application.

The present application further provides a computer non-transitory readable storage medium. The computer non-transitory readable storage medium stores a computer program. When the computer program is executed by a processor, the following steps may be implemented:
when the metadata of a logical volume has not been modified, marking the state of the metadata of the logical volume as a clean state; after the power of an all-flash storage system is restored, reading the state of the metadata of the logic volume; and if the metadata of the logical volume is in the clean state, restoring the metadata of the logical volume back online to an accessible state accessible by users.

The non-volatile readable storage medium may include any medium that can store program codes, such as a USB flash disk, a removable hard disk, a read-only memory (ROM), a random access memory (RAM), a magnetic disk, or an optical disk.

According to the non-volatile readable storage medium provided in the present application, when the metadata of a logical volume has not been modified, the state of the metadata is marked as a clean state, and subsequently, after a power loss failure occurs in an all-flash storage system and power is restored, if the state of the metadata of the logical volume is the clean state, power is directly restored, without the need of reconstructing the forward metadata, thereby achieving quick recovery after a power loss failure of an all-flash storage system occurs, shortening the recovery time, and improving the availability, reliability and security of the entire storage system.

For the description of the computer non-transitory readable storage medium provided in the present application, reference may be made to the foregoing method embodiments, and details are not repeatedly described herein.

The embodiments in this description are described in a progressive manner. Each embodiment focuses on differences from other embodiments. For the same similar parts among the embodiments, reference may be made to each other. For the apparatus, device and computer non-transitory readable storage medium disclosed in the embodiment, as they correspond to the method disclosed in the embodiment, the illustration thereof is relatively simple, and for the relevant parts, reference can be made to the illustration of the method part.

A person skilled in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraints of the technical solutions. A person skilled in the art may use different methods to implement the described functions for each particular application, but it should not be considered that the implementation goes beyond the scope of the present application.

In combination with embodiments disclosed in this specification, method or algorithm steps may be implemented by hardware, a software module executed by a processor, or a combination thereof. The software module may be provided in a random access memory (RAM), a memory, a read-only memory (ROM), an electrically programmable ROM, an electrically erasable programmable ROM, a register, a hard disk, a removable magnetic disk, a CD-ROM, or any other form of storage medium known in the art.

The foregoing describes in detail the recovery method, apparatus and device for the all-flash storage system, and the non-volatile computer readable storage medium provided in the present application. Specific examples have been applied herein to illustrate the principle and embodiments of the present application, and the description of the above embodiments is only used to help understand the method and core concept of the present application. It should be noted that for a person of ordinary skill in the present technical field, several improvements and modifications can also be made to the present application without departing from the principle of the present application, and these improvements and modifications shall fall within the scope of protection of the claims of the present application.

1. A method of recovering an all-flash storage system, comprising:
in a case where metadata of a logical volume has not been modified, marking a state of the metadata of the logical volume as a clean state;
after an all-flash storage system is powered back on, reading the state of the metadata of the logic volume; and
in a case where the metadata of the logical volume is in the clean state, restoring the metadata of the logical volume to an accessible state.

2. The method according to claim 1, wherein in a case where metadata of a logical volume has not been modified, marking a state of the metadata of the logical volume as a clean state comprises:
in a case where, within a preset timing period, there is no user-accessible data dispatched for the logical volume and the metadata of the logical volume has been written from a cache to a data storage device, marking the state of the metadata of the logical volume as the clean state.

3. The recovery method according to claim 2, wherein in a case where, within a preset timing period, there is no user-accessible data dispatched for the logical volume and the metadata of the logical volume has been written from a cache to a data storage device, marking the state of the metadata of the logical volume as the clean state comprises:
starting an idle task of writing the metadata of the logical volume from the cache to the data storage device, and determining whether the metadata of the logical volume has been written from the cache to the data storage device;
in a case where the metadata of the logical volume has been written from the cache to the data storage device, initiating a request for changing the state of the metadata as the clean state, to cause a control end of a state machine to trigger the state machine to run, and initiate a task of changing the state of the metadata as the clean state; and
executing the task, and marking the state of the metadata of the logical volume as the clean state.

4. The method according to claim 1, wherein in a case where the metadata of the logical volume is in the clean state, the restoring the metadata of the logical volume to an accessible state comprises:
in a case where the metadata of the logical volume is in the clean state, determining that forward metadata is stored in a hard disk, the forward metadata being configured to indicate a mapping relationship from a logical block address to a physical block address; and
reading the forward metadata from the hard disk to a memory, and restoring the metadata of the logical volume to the accessible state.

5. The method according to claim 1, wherein the marking a state of the metadata of the logical volume as a clean state comprises:
marking, in the logical volume, the state of the metadata of the logical volume as the clean state.

6. The method according to claim 5, wherein marking, in the logical volume, the state of the metadata of the logical volume as the clean state comprises:
marking, in a superblock of a header of the logical volume, the state of the metadata of the logical volume as the clean state.

7. The method according to claim 1, wherein the marking a state of the metadata of the logical volume as a clean state comprises:
marking, at a location other than the logical volume, the state of the metadata of the logical volume as the clean state.

8. The method according to claim 1, further comprising:
in a case where the metadata of the logical volume has not been modified, writing, into a superblock of a header of the logical volume, a root node address of a tree structure where the metadata is located.

9. The method according to claim 6, wherein the writing, into a superblock of a header of the logical volume, a root node address of a tree structure where the metadata is located comprises:
writing, into the superblock of the header of the logical volume, a root node address of a B+ tree where the metadata is located.

10. The method according to claim 9, wherein writing, into the superblock of the header of the logical volume, a root node address of a B+ tree where the metadata is located comprises:
in a case where, within a timing period, there is no user-accessible data dispatched for the logical volume and all modified metadata has been written from the cache to the data storage device, determining that all nodes of the B+ tree are in the clean state, wherein in a case where there is data to be written, a corresponding node on the B+ tree becomes a dirty state; and
marking, in the superblock of the logical volume, the state of the metadata of the logical volume as the clean state, and writing the root node address of the B+ tree.

11. The method according to claim 8, further comprising:
reading the root node address; and
accessing forward metadata of the logical volume according to the root node address.

12. The method according to claim 1, further comprising:
in a case where the metadata of the logical volume has been modified, marking the state of the metadata of the logical volume as a dirty state.

13. The method according to claim 12, wherein the marking the state of the metadata of the logical volume as the dirty state comprises:
marking, in the logical volume, the state of the metadata of the logical volume as the dirty state.

14. The method according to claim 13, wherein the marking, in the logical volume, the state of the metadata of the logical volume as the dirty state comprises:
marking, in a superblock of a header of the logical volume, the state of the metadata of the logical volume as the dirty state.

15. The method according to claim 12, wherein in a case where the metadata of the logical volume has been modified, marking the state of the metadata of the logical volume as the dirty state comprises:
in a case where there is written data dispatched for the logical volume, determining whether the state of the metadata of the logical volume is the clean state;
in a case where the state of the metadata of the logical volume is the clean state, initiating a request for changing the state of the metadata as the dirty state, to cause a control end of a state machine to trigger the state machine to run, and initiate a task of changing the state of the metadata as the dirty state; and
executing the task, and marking the state of the metadata of the logical volume as the dirty state.

16. The method according to claim 12, further comprising:
reconstructing forward metadata being configured to indicate a mapping relationship from a logical block address to a physical block address in a case where the state of the metadata of the logical volume is the dirty state, and restoring the metadata of the logical volume to the accessible state after the forward metadata is reconstructed.

17. The method according to claim 16, wherein the reconstructing the forward metadata comprises:
reading a logical partition space of the logical volume in a physical disk, and reconstructing the forward metadata using backward metadata.

18. The method according to claim 8, further comprising:
in a case where the state of the metadata of the logical volume is the clean state, and each time new user-accessible data is written, inserting a new mapping relationship from a logical block address to a physical block address into the tree structure, to cause at least one node of the tree structure to be changed to be modified and cause the tree structure to be in the dirty state.

19. A device of recovering the all-flash storage system, comprising:
a memory, configured to store a computer program; and
a processor, configured to implement the steps of the method of recovering the all-flash storage system according to claim 1 when executing the computer program.

20. A non-volatile computer readable storage medium, wherein the non-volatile computer readable storage medium stores a computer program which, when executed by the processor, implements the steps of the method of recovering the all-flash storage system according to claim 1.
